(19) United States
(12) Patent Application Publication
(10) Pub. No.: US 2007/0267123 A1
(43) Pub. Date: Nov. 22, 2007

(54) RAM modules customized marking system

(76) Inventor: Kin Sang Chong, Richmond Hill (CA)

Correspondence Address: DAVID W. WONG, 46 WILLOWBROOK ROAD, THORNHILL, ON, L3T 4W9, US

(21) Appl. No.: 11/438,113

(22) Filed: May 22, 2006

(51) Int. Cl. B32B 37/00

(52) U.S. Cl. 156/60

(57) ABSTRACT

A customized marking system is provided for RAM modules ordered by a customer from the manufacturer of the RAM modules. A first customized label is applied on each RAM module and a second customized label is applied on the packaging container of each individually module. The labels bear information of the identification of the manufacturer, identification of the customer, the customer's purchase order number, the manufacturer's invoice number and the part number and specifications of the RAM modules.

### BACKGROUND OF THE INVENTION

1. Field of the Invention

This invention relates to a marking system and more particularly to a customized marking and tracking system for RAM modules.

2. Background Art

Marking labels are commonly applied to products in manufacture and/or commerce. The label may bear the name or the trademark of the manufacturer or the supplier in order that purchasers of the product would recognize the origin of the product. The label also bears the product name and its specification such as its functional or operating ratings in order that the purchaser could select the product required based on the information. Some labels may also include the manufacture information such as the date of manufacture. Such labels would enable the manufacturer to track or trace the cause of any fault, if any, in the manufacturing equipment and/or process if a defective product is discovered subsequently in order that the fault may be rectified to prevent further problems.

In the electronic industry, a large number of RAM modules are purchased from RAM modules manufacturers by equipment assemblers or distributors or some individual computer owners. Normally, the RAM modules are installed into the equipment by the assembler or distributor, and the equipment are subsequently sold to end users. The RAM modules may not have any marking or may have just a simple label bearing their part numbers. When defective RAM modules are discovered either by the end user or by the assembler, they are usually returned to the RAM module manufacturer for replacement. When the manufacturer receive such a replacement request, it must first determine whether the defective modules were purchased from them before the replacement may be authorized. Such process of return and authorization of replacement by the manufacturer is usually complex and time consuming to carry out since it is difficult to confirm from the simple marking on the modules that the defective modules were acquired from them. The manufacturer upon receiving the return request from the equipment assembler must first search their records of invoice orders to determine if the product was acquired from them and then the manufacturing records must then be traced. It is only after such complex search, review and confirmation from various records, the manufacturer may then authorize the return and to provide the replacement to the assembler. The entire process is very time consuming, since it would require the review of the many different records in order that the replacement authorization process may proceed. For these reasons, it is often very frustrating for all the parties involved to carry out the replacement of RAM modules. Sometimes RAM modules are provided with each module contained within a packaging case having a clear plastic cover, and the markings are sometimes provided only on the case rather than on the RAM module itself. The case is commonly discarded during the equipment assembly. In such event, the traceability of the source of the module would be lost. Furthermore, if the assembler purchases RAM modules from more than one RAM module manufacturer, a replacement process would be extremely unwieldy to carry out.

### SUMMARY OF THE INVENTION

It is a principal object of the present invention to provide a customized marking system of RAM modules.

It is another object of the present invention to provide a customized marking system which provides all information to facilitate identification of the RAM module so that in case of a defective module found after sale authorization of replacement may be carried out readily.

It is another object of the present invention to provide a customized marking system for RAM modules indicative of both the manufacturer and the electronic equipment assembler.

It is another object of the present invention to provide a marking system on both the RAM module and the individual packaging container such that tracking of the module may be carried out even if the packaging container has been discarded.

### BRIEF DESCRIPTION OF THE DRAWINGS

Other objects and advantages of the present invention will become apparent from the following detailed description of the preferred embodiments thereof in connection with the accompanying drawings, in which

FIG. 1 is a schematic diagram showing the information provided on the customized label affixed to the RAM module according to the present invention.

FIG. 2 is a schematic diagram showing the information provided on the customized label affixed to the packaging container of the RAM module.

FIG. 3 is a photograph showing the provision of customized marking labels affixed on both the RAM module and on the packaging container.

### DETAILED DESCRIPTION OF THE PREFERRED EMBODIMENT

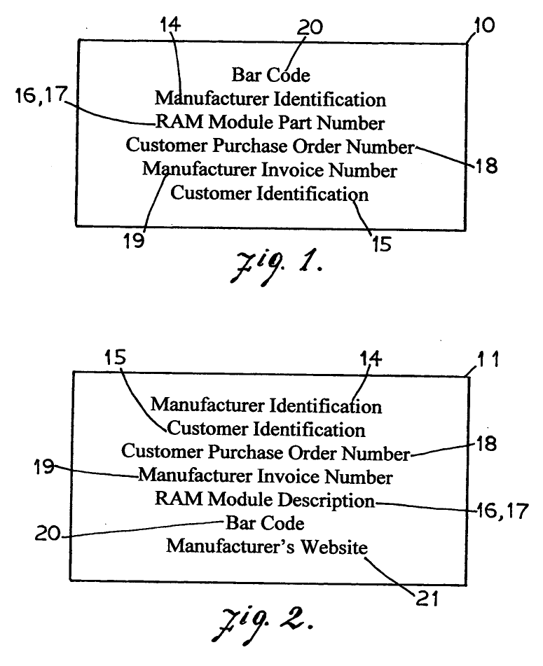

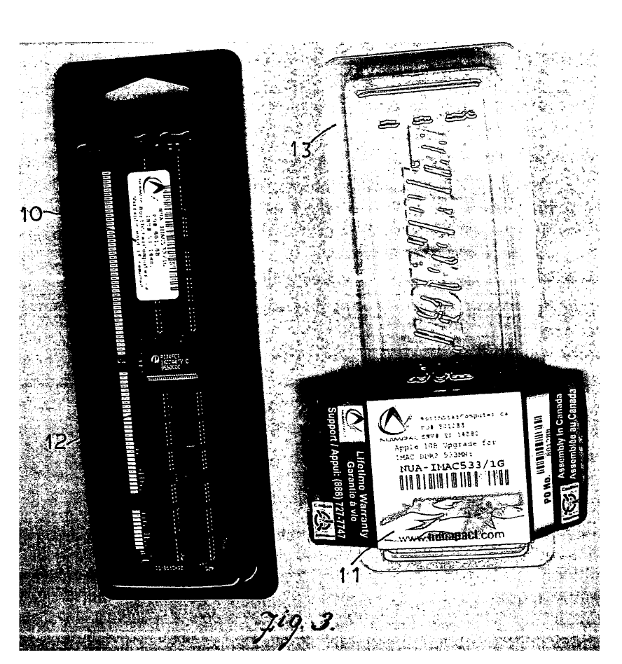

According to the present invention, when a RAM module manufacturer receiving a purchase order from a particular customer, the RAM modules are fabricated and are provided with customized marking labels 10 and 11 as shown in FIGS. 1 and 2, for each RAM module 12 before the order is shipped to the particular customer. The marking label 10 is affixed to the RAM module 12 while the label 11 is affixed to the outer surface of the packaging container cover 13 of the individual module. In order to facilitate tracking of the RAM module 12, each label is provided with customized information. As shown in FIG. 1, the label 10 affixed to the RAM module is provided with the manufacturer's identification in the form of a trademark and/or logo 14; the customer's identification in the form of the customer's internet website and/or logo and/or name 15; customer's product code or part number 16; manufacturer's part number and description 17; customer's purchase order number 18; the manufacturer's invoice number 19; and additionally a bar code 20 of the same information and inventory information. The label 11 affixed to the packaging container 13 may also bear fuller specifications 17 of the RAM to facilitate selection of the RAM module to meet the requirement by the purchaser, and the manufacturer's internet website 21. Such customized labels are particularly useful in the identification of the RAM module so that in case of any defective module is uncovered subsequently after sale, the information on the labels 10 and 11 provide immediate confirmation of its origin so that the authorization of its replacement may be proceeded readily without delay. Even in the event, the packaging container 13 is discarded during use, the customized label 10 affixed on the module provides all the information required for the authorization of replacement.

The identification of the purchaser of the module from the manufacturer provided on the customized labels is particularly useful if the defective RAM module is discovered by a computer owner such that the defective part may be returned to the module purchaser in order that it may be returned to the manufacturer for replacement.

The bar code 20 provided on both of the customized labels 10 and 11 facilitates the modules in the shipment be scanned electronically into an electronic data base maintained by the manufacturer for inventory and similar purposes.

The additional internet website information of the manufacturer provided in the customized label 11 allows customers whether assembler or end user to contact the manufacturer for any technical information.

While the present invention has been shown and described in the preferred embodiment thereof, it will be apparent that various modifications can be made therein without departing from the spirit or essential attributes thereof, it is desired therefore that only such limitations be placed thereon as are imposed by the appended claims.

What is claimed is:

1. A customized marking system for RAM modules ordered by a purchaser from a manufacturer of said RAM modules, comprising:
applying a first customized label to each one of said RAM modules,
applying a second customized label to an outer surface each packaging container for each one of said RAM modules individually,
said first customized label bearing customized information of said manufacturer of said RAM module, part number and specification of said RAM module, purchase order number of said customer, invoice number of said manufacturer, identification of said customer, and an information bar code,
said second customized label bearing same information as said first customized label and additionally identification of said customer and identification and an internet website of said manufacturer.

2. A customized marking system for RAM modules according to claim 1 wherein said information of said manufacturer includes a trade mark logo of said manufacturer.

3. A customized marking system for RAM modules according to claim 2 wherein said identification of said customer is an internet website of said customer.

4. A customized marking system for RAM modules purchased by a customer from manufacturer of said RAM modules, comprising:
a first customized label applied on each one of said RAM modules,
a second customized label applied on an outer surface of individual packaging container of each one of said RAM modules,
said first customized label bearing an identification mark of said manufacturer, part number of said RAM modules, purchase order of said RAM module by said customer, invoice number of said RAM modules by said manufacturer, identification of said customer, and an electronically readable bar code containing specification information and inventory information of said RAM modules,
said second customized label bearing same information as said first customized label and additionally an internet website of said manufacturer.

5. A customized marking system of RAM modules according to claim 4 wherein said second customized label includes technical specifications of said RAM modules.
